(19) United States
(12) Patent Application Publication
(10) Pub. No.: US 2024/0136621 A1
(43) Pub. Date: Apr. 25, 2024

(54) BATTERY AND ELECTRONIC DEVICE

(71) Applicant: ZHUHAI COSMX BATTERY CO., LTD., Zhuhai (CN)

(72) Inventors: Longyun CHEN, Zhuhai (CN); Yuxiang ZENG, Zhuhai (CN); Zhida WEI, Zhuhai (CN); Yongwang WANG, Zhuhai (CN); Zhifeng WANG, Zhuhai (CN); Haixia JIANG, Zhuhai (CN)

(73) Assignee: ZHUHAI COSMX BATTERY CO., LTD., Zhuhai (CN)

(21) Appl. No.: 18/400,995

(22) Filed: Dec. 29, 2023

Related U.S. Application Data
(63) Continuation-in-part of application No. PCT/CN2022/133329, filed on Nov. 21, 2022.
Application No. PCT/CN2022/133329 is a continuation-in-part of application No. PCT/CN2022/118605, filed on Sep. 14, 2022.

(30) Foreign Application Priority Data
Sep. 17, 2021 (CN) 202111112948.2
Dec. 30, 2021 (CN) 202123448928.0

(51) Int. Cl. H01M 50/188; H01M 50/147

(52) U.S. Cl. CPC H01M 50/188; H01M 50/147; H01M 50/109

(57) ABSTRACT

Disclosed are a battery and an electronic device, including a housing, a sealing cover, and a battery cell. The housing has an accommodation cavity, and the battery cell is located in the accommodation cavity. The housing is provided with a liquid injection hole. An upper surface of a peripheral edge of the sealing cover is provided with a first step, and the first step divides the sealing cover into a first cover area and a second cover area. The thickness of the second cover area is less than or equal to a thickness of the housing at a seal-welding position with the second cover area. The battery provided in embodiments of the present disclosure has good seal-welding performance, to resolve problems of low battery yields, difficulty in mass production, and failure to achieve expected safety and stability due to poor seal-welding performance.

### CROSS-REFERENCE TO RELATED APPLICATIONS

The present disclosure is a continuation-in-part of International Application No. PCT/CN2022/133329, filed on Nov. 21, 2022, which claims priority to Chinese Application No. CN202123448928.0, filed on Dec. 30, 2021. The present disclosure is also a continuation-in-part of International Application No. PCT/CN2022/118605, filed on Sep. 14, 2022, which claims priority to Chinese Application No. CN202111112948.2, filed on Sep. 18, 2021. All of the aforementioned patent applications are hereby incorporated by reference in their entireties.

### TECHNICAL FIELD

This present disclosure relates to the technical field of battery structures, and in particular, to a battery and an electronic device.

### BACKGROUND

With the development of economies and the advancement of science and technology, smart products have penetrated into every aspect of people's lives. In order to improve user experience of the smart products, the smart products are increasingly becoming lighter and smaller. Lithium-ion button batteries that can be recharged and used repeatedly have been gradually used in various fields of people's daily lives, for example, wearable devices, computer products, and medical products.

Due to limitations of conventional technologies, processes of manufacturing lithium-ion button batteries are relatively complex and it is difficult to manufacture them. Seal-welding performance has significant impact on overall performance of the batteries. Poor seal-welding performance leads to low yields and difficulty in mass production, and further makes it difficult for safety and stability of the batteries to achieve expected goals. Therefore, there is an urgent need for a battery structure solution with a compact structure and good seal-welding performance to achieve a high battery yield, high mass production, high safety, and high stability.

### SUMMARY

This present disclosure provides a battery and an electronic device, which have good seal-welding performance, to resolve problems of low battery yields, difficulty in mass production, and failure to achieve expected safety and stability due to poor seal-welding performance.

A battery provided in an embodiment of the present disclosure includes: a housing, a sealing cover, and a battery cell. The housing has an accommodation cavity, and the battery cell is located in the accommodation cavity. The housing is provided with a liquid injection hole, the liquid injection hole is communicated with the accommodation cavity, and the sealing cover is seal-welded to the housing to cover the liquid injection hole. An upper surface of a peripheral edge of the sealing cover is provided with a first step, the first step divides the sealing cover into a first cover area and a second cover area, and a thickness of the first cover area is greater than a thickness of the second cover area. The thickness of the second cover area is less than or equal to a thickness of the housing at a seal-welding position with the second cover area.

According to the battery provided in the embodiment of the present disclosure, the first step is disposed on the sealing cover that covers the liquid injection hole, the first step divides the sealing cover into the first cover area and the second cover area, and the thickness of the second cover area is less than or equal to the thickness of the housing at the seal-welding position with the second cover area. On the one hand, the second cover area is formed by thinning a thickness of a part of the sealing cover through the first step, so that heat of laser can successfully reach a welding surface, to enhance a welding stability of the sealing cover and improve a seal-welding yield. On the other hand, the second cover area serves as an upper material for welding of the sealing cover and the housing, and the thickness of the second cover area is set to be less than or equal to a thickness of the housing at a seal-welding position with the second cover area, which can reduce a risk of electrolyte solution leakage resulting from welding through the housing, and improve a yield of a processing and assembly process.

In a possible implementation, the adapter is further included. The adapter is welded to an upper surface of the first cover area, and a thickness of the adapter is less than or equal to a thickness of the first cover area at a welding position with the adapter.

In a possible implementation, the housing includes: a housing body and a cover assembly. The housing body and the cover assembly enclose an accommodating cavity. The cover assembly includes: a cover plate, a top cover, and a first insulation member. The cover plate is seal-welded to the housing body, and the cover plate is provided with a through-hole. The top cover is provided with a recessed portion, and the recessed portion is located in the through-hole. The recessed portion is provided with the liquid injection hole, and the first insulation member is disposed between the top cover and the cover plate, to insulatedly connect the top cover and the cover plate. A first groove is formed above the recessed portion, and the sealing cover is disposed in the first groove.

In a possible implementation, a second step is disposed on a lower surface of a peripheral edge of the cover plate, and the second step is seal-welded to the housing body.

In a possible implementation, a second groove is disposed on an upper surface of the cover plate, and at least a part of the first insulation member is disposed in the second groove.

In a possible implementation, a third groove is formed on the upper surface of the recessed portion, the liquid injection hole is located in the third groove, and the sealing cover covers the third groove; and an aperture of the third groove is greater than an aperture of the liquid injection hole.

In a possible implementation, the battery cell includes: a battery cell body and a first tab and a second tab connected to the battery cell body. The first tab is connected to the top cover, and the second tab is connected to the housing body.

In a possible implementation, a second insulation member is further included. The second insulation member is disposed on an upper surface and/or a lower surface of the battery cell body.

In a possible implementation, a third insulation member is further included. The third insulation member is disposed between the cover plate and the first tab.

In a possible implementation, protective glue is further included. The protective glue covers a portion, protruding from the battery cell body, of the first tab, and/or a portion, protruding from the battery cell body, of the second tab.

In a possible implementation, the housing includes a housing body and a cover assembly. The housing body and the cover assembly enclose an accommodating cavity. The cover assembly includes: a cover plate, where the cover plate is connected to a top of the housing, and the cover plate is provided with a through-hole; and a second conductive member, where the second conductive member is insulatedly connected to a surface, close to the accommodation cavity, of the cover plate, at least a partial structure of the second conductive member is exposed from the through-hole, and a part of the second conductive member exposed from the through-hole is provided with a liquid injection hole. The sealing cover is located on the second conductive member.

In a possible implementation, the second conductive member includes a first connection portion and a second connection portion disposed around an outer edge of the first connection portion, and a thickness of the first connection portion is greater than a thickness of the second connection portion. The second connection portion is insulatedly connected to the cover plate, the first connection portion is located in the through-hole, and the sealing cover is connected to a surface, facing away from the accommodation cavity, of the first connection portion.

In a possible implementation, an isolation layer is further disposed between the through-hole and the first connection portion, and the isolation layer is sandwiched between a side wall of the first connection portion and a hole wall of the through-hole.

In a possible implementation, a top surface of the first connection portion is flush with a top surface of the cover plate; or a height of the top surface of the first connection portion relative to a bottom of the battery is higher than a height of the top surface of the cover plate relative to the bottom of the battery; or a height of the top surface of the first connection portion relative to the bottom of the battery is lower than a height of the top surface of the cover plate relative to the bottom of the battery.

In a possible implementation, the first cover area includes a protruding portion protruding from the second cover area, where a top surface of the protruding portion is flush with a top surface of the cover plate; or a height of the top surface of the protruding portion relative to the bottom of the battery is higher than a height of the top surface of the cover plate relative to the bottom of the battery; or a height of the top surface of the protruding portion relative to the bottom of the battery is lower than a height of the top surface of the cover plate relative to the bottom of the battery.

In a possible implementation, the housing body includes a bottom wall and a side wall surrounding and connected to an edge of the bottom wall, and a top of the side wall is connected to an edge portion of the cover plate.

In a possible implementation, the cover plate has a positioning recess at a position near the edge, the positioning recess is located on a surface, facing the battery cell, of the cover plate, and the top of the side wall is connected to the positioning recess.

In a possible implementation, the battery cell includes a first tab and a second tab. The second tab is electrically connected to the cover plate, and the first tab is electrically connected to the second conductive member. An outer contour edge of the second conductive member is provided with a positioning mark, and the positioning mark is used to indicate a welding position of the first tab on the second conductive member.

A battery provided in the embodiment of the present disclosure includes a housing, where the housing has an accommodating cavity; a battery cell, where the battery cell is located inside the accommodating cavity; a cover assembly, where the cover assembly is disposed on the housing, and the cover assembly includes: a cover plate, where the cover plate is connected to a top of the housing, and the cover plate is provided with a through-hole; and a second conductive member, where the second conductive member is insulatedly connected to a surface, close to the accommodation cavity, of the cover plate, at least a partial structure of the second conductive member is exposed from the through-hole, and a part of the second conductive member exposed from the through-hole is provided with a liquid injection hole; and a sealing cover located on the second conductive member, where the sealing cover covers the liquid injection hole.

An electronic device provided in the embodiment of the present disclosure includes an electronic device body and the battery described above. The battery provides electric energy for the electronic device body.

### BRIEF DESCRIPTION OF THE DRAWINGS

To describe the technical solutions of the embodiments of the present disclosure or in conventional technology more clearly, the following briefly describes the accompanying drawings required for describing the embodiments or the conventional technology. Apparently, the accompanying drawings in the following description show some embodiments of the present disclosure, and a person of ordinary skill in the art can still derive other accompanying drawings from these accompanying drawings without creative efforts.

FIG. 1 is a schematic diagram of a structure of a battery according to an embodiment of the present disclosure.

FIG. 2 is a schematic cross-sectional diagram of a structure of a battery according to an embodiment of the present disclosure.

FIG. 3 is another schematic cross-sectional diagram of a structure of the battery in FIG. 2.

FIG. 4 is a schematic diagram of structures of a cover assembly and a sealing cover in FIG. 2 and FIG. 3.

FIG. 5 is a schematic cross-sectional diagram of a structure of a battery according to an embodiment of the present disclosure.

FIG. 6 is another schematic cross-sectional diagram of a structure of the battery in FIG. 5.

FIG. 7 is a schematic diagram of structures of a cover assembly and a sealing cover in FIG. 5 and FIG. 6.

FIG. 8 is a schematic cross-sectional diagram of a structure of a battery according to an embodiment of the present disclosure.

FIG. 9 is another schematic cross-sectional diagram of a structure of the battery in FIG. 8.

FIG. 10 is a schematic diagram of structures of a cover assembly and a sealing cover in FIG. 8 and FIG. 9.

FIG. 11 is a schematic diagram of a structure of a battery according to another embodiment of the present disclosure.

FIG. 12 is a top view of a battery according to an embodiment of the present disclosure.

FIG. 13 is a cross-sectional view along a line A-A in FIG. 12.

FIG. 14 is a locally enlarged view of a position B in FIG. 13.

FIG. 15 is a schematic overall structural diagram of another structure of a battery according to an embodiment of the present disclosure.

FIG. 16 is a schematic diagram of a structure of a second conductive member in a battery according to an embodiment of the present disclosure.

### DETAILED DESCRIPTION OF THE EMBODIMENTS

To make the objectives, technical solutions, and advantages of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

A battery refers to an apparatus that has a cup, a tank, or another container or composite container holding an electrolyte solution and metal electrodes to generate an electric current and that can convert chemical energy into electrical energy. A button battery is used as an example. A shape and size of the button battery are similar to those of a button. Button batteries generally have large diameters and small thicknesses. They are widely used in electronic devices such as electronic watches, Bluetooth headsets, electric toys and so on.

A battery provided in the embodiments of the present disclosure may be the button battery, a cylindrical battery, a special-shaped battery, or another type of battery. In the embodiments of the present disclosure, a button-type polymer lithium-ion battery is used as an example for description.

Due to advantages of their small sizes, the button batteries are widely used in various micro electronic devices. Their diameters range from 4.8 mm to 30 mm, and their thicknesses range from 1 mm to 7.7 mm. They are generally used as backup power sources for various electronic devices, such as computer motherboards, electronic watches, electronic dictionaries, electronic scales, remote controls, electric toys, heart pacemakers and so on. The button battery mainly generates electrical energy through a chemical reaction between a positive electrode material and a negative electrode material in an electrolyte solution inside a battery cavity.

Due to limitations of conventional technologies, processes of manufacturing the button batteries are relatively complex and it is difficult to manufacture them. Seal-welding performance has significant impact on overall performance of the batteries. Poor seal-welding performance leads to low yields and difficulty in mass production, and further makes it difficult for safety and stability of the batteries to achieve expected goals.

In view of this, according to the battery provided in the embodiments of the present disclosure, a first step is disposed on a sealing cover covered on a liquid injection hole. The first step divides the sealing cover into a first cover area and a second cover area. A thickness of the second cover area is less than or equal to a thickness of a sealing part for welding between a housing and the second cover area. On the one hand, the second cover area is formed by thinning a thickness of a part of the sealing cover can enhance a welding stability of the sealing cover and improve a seal-welding yield. On the other hand, as an upper material in welding of the second cover area and the housing, the second cover area has a thickness less than or equal to a thickness of the housing at a corresponding welding position, which may reduce a risk of leakage resulting from welding through the housing, and improve a yield of a processing and assembly process.

The following describes in detail the battery provided in the embodiments of the present disclosure with reference to the accompanying drawings and specific embodiments.

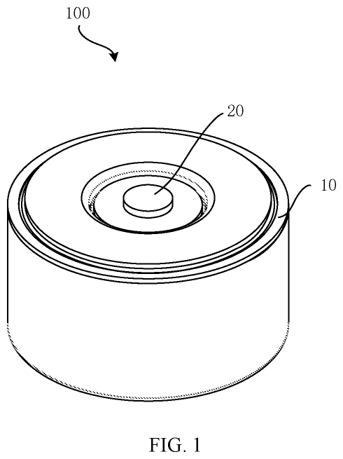

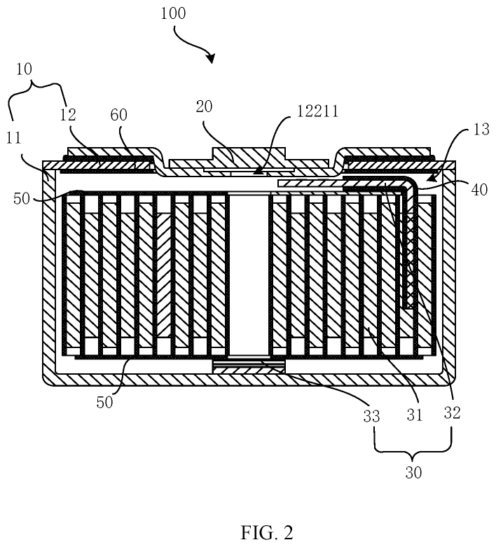

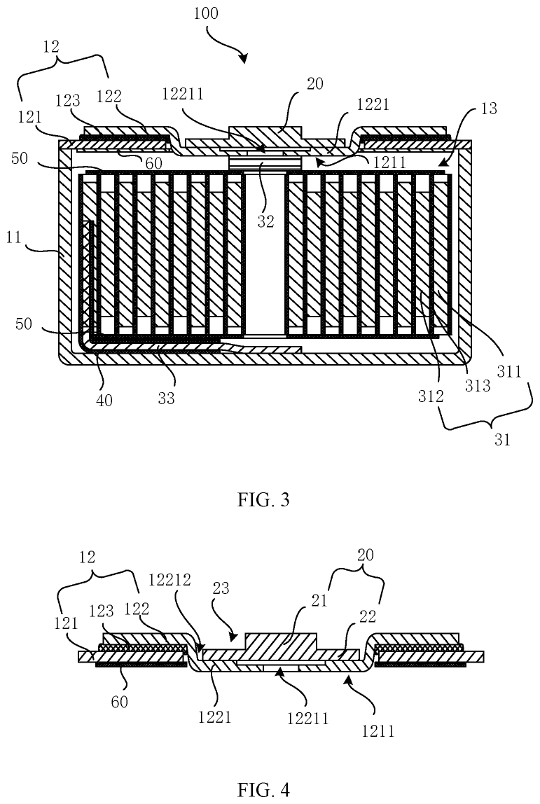

FIG. 1 is a schematic diagram of a battery 100 according to an embodiment of the present disclosure FIG. 2 is a schematic cross-sectional diagram of a structure of a battery 100 according to an embodiment of the present disclosure. FIG. 3 is another schematic cross-sectional diagram of a structure of the battery 100 in FIG. 2.

Refer to FIG. 1 to FIG. 3. The battery 100 provided in the embodiment of the present disclosure includes a housing 10, a sealing cover 20, and a battery cell 30. The housing 10 has an accommodation cavity 13, and the battery cell 30 is located inside the accommodation cavity 13.

The housing 10 is provided with a liquid injection hole 12211. The liquid injection hole 12211 is communicated with the accommodation cavity 13, and the liquid injection hole 12211 is used for injection of an electrolyte solution. The battery cell 30 experiences a chemical reaction in the electrolyte solution to generate electrical energy. The sealing cover 20 is seal-welded to the housing 10 to cover the liquid injection hole 12211. In addition, an outer diameter of the sealing cover 20 is greater than an inner diameter of the liquid injection hole 12211, so that the sealing cover 20 can be successfully welded to an outer surface of the housing 10.

Specifically, reference may be made to FIG. 4. FIG. 4 is a schematic diagram of structures of a cover assembly 12 and the sealing cover 20 in FIG. 2 and FIG. 3. An upper surface of a peripheral edge of the sealing cover 20 is provided with a first step 23. The first step 23 divides the sealing cover 20 into a first cover area 21 and a second cover area 22. A thickness of the first cover area 21 is greater than a thickness of the second cover area 22. From a cross-sectional diagram of the sealing cover 20, the sealing cover 20 is in the shape of an inverted “T”. Laser hits an upper surface of the second cover area 22, and heat of the laser causes the sealing cover 20 and the housing 10 to be welded and sealed together. In order to ensure welding performance, in the embodiment of the present disclosure, the thickness of the second cover area 22 is set to be less than or equal to a thickness of the housing 10 at a seal-welding position with the second cover area 22.

It should be understood that, the second cover area 22 is formed by thinning a thickness of a part of the sealing cover 20, so that heat of laser can successfully reach a welding surface, to enhance the welding stability of the sealing cover 20 and improve the seal-welding yield. Further, the second cover area 22 serves as an upper material for welding of the sealing cover 20 and the housing 10, and the thickness of the second cover area 22 is set to be less than or equal to a thickness of the housing 10 at a seal-welding position with the second cover area 22. This can reduce the risk of electrolyte solution leakage resulting from welding through the housing 10, and improve the yield of the processing and assembly process.

In some embodiments of the present disclosure, the thickness of the first cover area 21 may be set within a range from 0.1 mm to 1.5 mm, and the thickness of the second cover area 22 may be set within a range from 0.05 mm to 1 mm.

Certainly, the present disclosure is not limited thereto. In some embodiments of the application, in order to connect the battery 100 to a circuit structure inside an electronic device, an adapter (not shown in the figure) is usually included. The adapter is provided with pins, and the pins are electrically connected to the circuit structure inside the electronic device to transfer electric energy in the battery 100 to the electronic device. In order to the ensure stability of welding of the adapter to the sealing cover 20, the adapter is welded to an upper surface of the first cover area 21 of the sealing cover 20, to reduce a risk of leakage resulting from welding through the sealing cover 20. A thickness of the adapter is less than or equal to a thickness of the first cover area at a welding position with the adapter, so that the first cover area 21 serving as a lower material of the adapter and the sealing cover 20 is not welded through, further reducing the risk of electrolyte solution leakage and improving the yield of the processing and assembly process.

Still refer to FIG. 2 to FIG. 4. In some embodiments of the present disclosure, the housing 10 includes: a housing body 11 and a cover assembly 12. The housing body 11 and the cover assembly 12 enclose the accommodation cavity 13.

With reference to FIG. 4, the cover assembly 12 includes: a cover plate 121, a top cover 122, and a first insulation member 123. The cover plate 121 is seal-welded to the housing body 11, and the cover plate 121 is provided with a through-hole 1211. The top cover 122 has a recessed portion 1221, and the recessed portion 1221 is disposed in the through-hole 1211 to reduce an overall height of the battery 100. The liquid injection hole 12211 is disposed on the recessed portion 1221. The first insulation member 123 is disposed between the top cover 122 and the cover plate 121 to insulatedly connect the top cover 122 and the cover plate 121. The top cover 122, the first insulation member 123, and the cover plate 121 may be sealed and connected by thermal welding.

The top cover 122 is made of a metal material, which is usually stainless steel or nickel. The cover plate 121 is a stretched annular plate. An outer diameter of the top cover 122 is 0.1 mm-2 mm smaller than an outer diameter of the cover plate 121. The first insulation member 123 may be made of PP (Polypropylene Mucilage) glue, a main component of which is ethyl cyanoacrylate.

A first groove 12212 is formed above the recessed portion 1221, and the sealing cover 20 is disposed in the first groove 12212. On the one hand, the first groove 12212 may limit a position of the sealing cover 20. On the other hand, the sealing cover 20 is disposed in the first groove 12212 helps reduce an overall height of the battery 100.

It should be mentioned that, with reference to FIG. 2 and FIG. 3, the battery cell 30 includes: a battery cell body 31 and a first tab 32 and a second tab 33 connected to the battery cell body 31. The battery cell body 31 experiences a reaction in the electrolyte solution to generate electric energy. The first tab 32 may be a positive tab or a negative tab, and correspondingly, the second tab 33 may be a negative tab or a positive tab. The first tab 32 is electrically connected to the top cover 122 to form a positive electrode of the housing or a negative electrode of the housing. Correspondingly, the second tab 33 is electrically connected to the housing body 11 or the cover plate 121 to form the negative electrode of the housing or the positive electrode of the housing. Some sections of the first tab 32 and the second tab 33 are covered with the protective glue 40. The protective glue 40 covers a portion, protruding from the battery cell body 31, of the first tab 32, and/or a portion, protruding from the battery cell body 31, of the second tab 33, to protect the first tab 32 and the second tab 33.

A second insulation member 50 is disposed on an upper surface and/or a lower surface of the battery cell body 31. To be specific, the second insulation member 50 may be disposed on the upper surface of the battery cell body 31, or the second insulation member 50 may be disposed on the lower surface of the battery cell body 31, or the second insulation member 50 may be disposed on each of the upper and lower surfaces of the battery cell body 31. In the accompanying drawings of the present disclosure, that the second insulation member 50 is disposed on each of the upper and lower surfaces of the battery cell body 31 is used as an example for description. The second insulation member 50 serves to insulate the battery cell body 31 from the surroundings, so that the battery cell body 31 and the housing 10 do not form a complete path.

In addition, the battery 100 provided in the embodiment of the present disclosure further includes: a third insulation member 60. The third insulation member 60 is disposed between the cover plate 121 and the first tab 32. For example, in some embodiments of the present disclosure, the third insulation member 60 is disposed on a lower surface of the cover plate 121 for insulation from the first tab 32. The third insulation member 60 is generally made of a non-metallic insulation material, with a thickness between 0.02 mm and 0.1 mm, preferably, between 0.03 mm and 0.05 mm.

The battery cell 30 may be a jelly-roll battery cell 30. The battery cell body 31 is formed by stacking a first electrode 311, a second electrode 312, and a separator 313 in sequence and winding them from one end to the other (as shown in FIG. 4). In order to ensure safety performance of the battery 100, a total area of the first electrode 311 is greater than a total area of the second electrode 312, so that the second electrode 312 is covered by the first electrode 311. Certainly, the battery cell 30 provided in the embodiment of the present disclosure is not limited to the foregoing examples, and may alternatively be a laminated-type battery cell or the like.

After the first tab 32 and the second tab 33 are separately led out from the battery cell body 31, in some embodiments of the present disclosure, relative positions of the first tab 32 and the second tab 33 may be arranged as follows: An angle between an orthographic projection of the first tab 32 onto a bottom surface of the housing body 11 and an orthographic projection of the second tab 33 onto the bottom surface of the housing body 11 ranges from 90° to 180°. In this way, it may be ensured that the first tab 32 and the second tab 33 do not affect each other. Certainly, in some other embodiments of the present disclosure, the angle between the orthographic projection of the first tab 32 onto the bottom surface of the housing body 11 and the orthographic projection of the second tab 33 onto the bottom surface of the housing body 11 may alternatively range from 0° to 90°, provided that the first tab 32 and the second tab 33 do not affect each other. No limitation is imposed herein.

It should be noted that a structure of the housing 10 of the battery 100 provided in the embodiment of the present disclosure is not limited to the foregoing examples. For example, the housing 10 may alternatively be formed by connecting and splicing an upper housing with an open end and a lower housing with an open end. The upper housing and the lower housing enclose the accommodation cavity 13, and an insulation layer for isolating the upper housing from the lower housing is sandwiched between splicing surfaces of the upper housing and the lower housing, so that the upper housing and the lower housing respectively serve as the positive electrode and the negative electrode of the battery 100. The liquid injection hole 12211 is disposed on the upper housing, and the sealing cover 20 covers the liquid injection hole 12211. Herein, the structure of the housing 10 of the battery 100 is not limited.

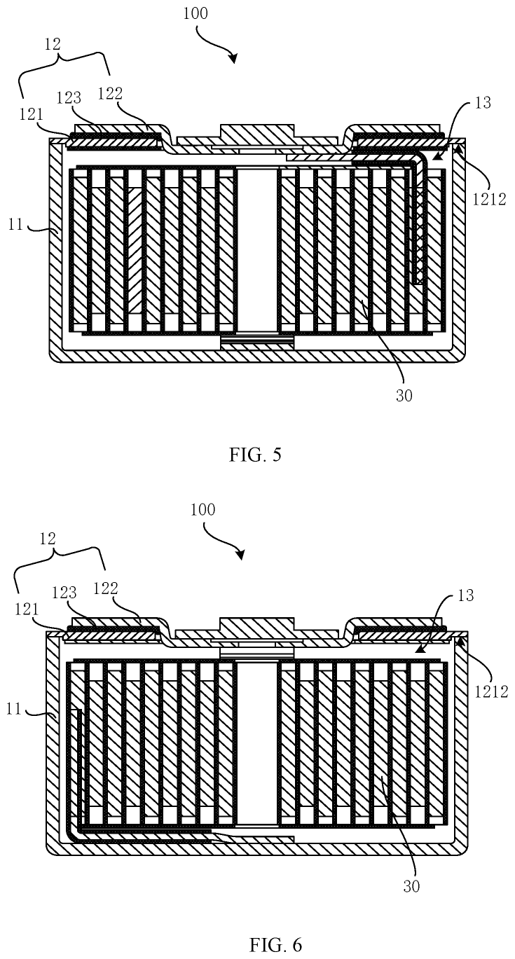

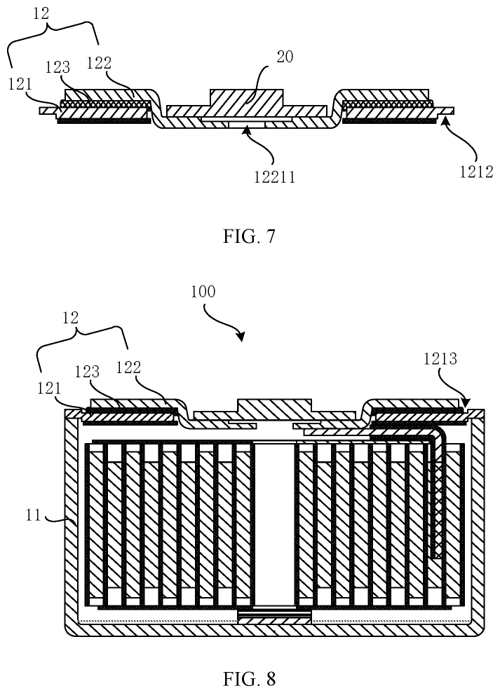

FIG. 5 is a schematic cross-sectional diagram of a structure of a battery 100 according to an embodiment of the present disclosure. FIG. 6 is another schematic cross-sectional diagram of a structure of the battery 100 in FIG. 5. FIG. 7 is a schematic diagram of structures of the cover assembly 12 and the sealing cover 20 in FIG. 5 and FIG. 6.

Refer to FIG. 5 to FIG. 7, in some embodiments of the present disclosure, a second step 1212 is disposed on a lower surface of a peripheral edge of the cover plate 121 of the cover assembly 12, and the second step 1212 is seal-welded to the housing body 11. Through arrangement of the second step 1212, the battery cell 30 is misaligned with side welding laser, effectively preventing the laser from burning the battery cell 30 during seal-welding of the cover plate 121 to the housing body 11. When the battery cell 30 is the jelly-roll battery cell, the second step 1212 may further press a separator 313 into the accommodation cavity 13 to prevent the separator 313 from being clamped in a weld gap between the cover plate 121 and the housing body 11, which leads occurrence of poor welding sealing. In some embodiments of the present disclosure, a width of the second step 1212 (in a horizontal direction of the second step 1212) may be set between 0.1 mm and 1 mm, and a depth of the second step 1212 (in a vertical direction of the second step 1212) may be set between 0.02 mm and 0.5 mm.

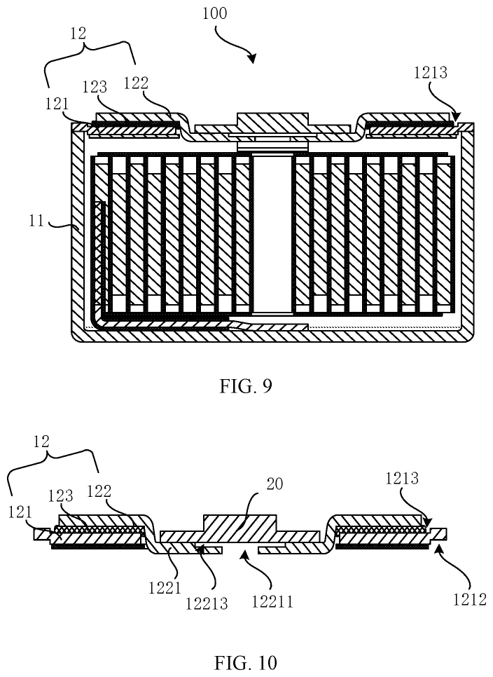

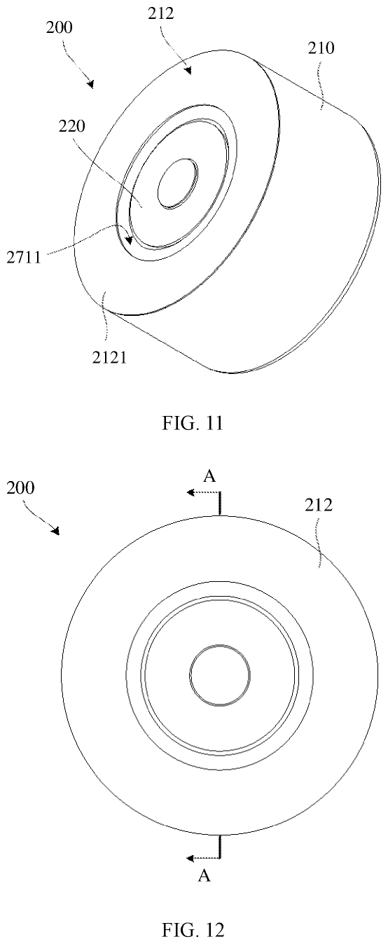

FIG. 8 is a schematic cross-sectional diagram of a structure of a battery 100 according to an embodiment of the present disclosure. FIG. 9 is another schematic cross-sectional diagram of a structure of the battery 100 in FIG. 8. FIG. 10 is a schematic diagram of structures of the cover assembly 12 and the sealing cover 20 in FIG. 8 and FIG. 9.

Refer to FIG. 8 to FIG. 10. In some embodiments of the present disclosure, a second groove 1213 is disposed on an upper surface of the cover plate 121 of the cover assembly 12, and at least a part of the first insulation member 123 is disposed in the second groove 1213. It should be explained that when the recessed portion 1221 and the cover plate 121 are not easy to come into contact, the first insulation member 123 is entirely disposed in the second groove 1213. When a gap between the recessed portion 1221 and the cover plate 121 is too small, a part of the first insulation member 123 needs to be disposed between the recessed portion 1221 and the cover plate 121. In this case, the part of the first insulation member 123 is disposed in the second groove 1213, and the part of the first insulation member 123 is disposed between the recessed portion 1221 and the cover plate 121.

It can be understood that the second groove 1213 may accommodate overflowing glue generated during thermal welding of the first insulation member 123, to prevent the first insulation member 123 from overflowing, and ensure welding performance between the top cover 122 and the cover plate 121.

An outer diameter of the second groove 1213 may be set to be 0.1 mm to 1 mm smaller than an outer diameter of the cover plate 121, so that an area of the first insulation member 123 can be large enough to strengthen overall connectivity between the top cover 122 and the cover plate 121. The depth of the second groove 1213 may be set between 0.02 mm and 0.5 mm.

It should be mentioned that when in an embodiment, both the second step 1212 and the second groove 1213 are included, an inner diameter of the second step 1212 may approximately coincide with the outer diameter of the second groove 1213, so as to facilitate integral forming of the cover plate 121.

Still refer to FIG. 10. In some embodiments of the present disclosure, a third groove 12213 may be further disposed on the upper surface of the recessed portion 1221. The liquid injection hole 12211 is located in the third groove 12213, and the sealing cover 20 covers the third groove 12213. In addition, an aperture of the third groove 12213 is greater than an aperture of the liquid injection hole 12211. The third groove 12213 may be configured to buffer the electrolyte solution. During subsequent welding and packaging of the battery 100, the electrolyte solution expands due to heat and flows into the third groove 12213, to prevent the battery 100 from bulging or cracking due to expansion of the electrolyte solution.

It should be mentioned that the third groove 12213 and the liquid injection hole 12211 may be in any shape, for example, circular, square, irregularly shaped, or the like. Generally, the third groove 12213 and the liquid injection hole 12211 are circular or square. In this case, a diameter or a side length of the third groove 12213 may be set between 0.5 mm and 4 mm, and a depth may be set between 0.02 mm and 0.5 mm. A diameter or a side length of the liquid injection hole 12211 is set between 0.2 mm and 3 mm.

In summary, the battery 100 provided in the embodiment of the present disclosure has good seal-welding performance, to resolve problems of low battery yields, difficulty in mass production, and failure to achieve expected safety and stability due to poor seal-welding performance. Moreover, the battery 100 provided in the embodiment of the present disclosure further has characteristics of a compact structure and strong implementability.

The following describes a method for assembling the battery 100 in an embodiment.

The second insulation member 50 is attached to upper and lower surfaces of the battery cell 30 to insulate the battery cell 30 from a surrounding metal part. After the battery cell 30 is placed in the accommodation cavity 13, the second tab 33 is welded to the bottom of the housing body 11, and a welding point is at a center hole of the battery cell 30. The first tab 32 is welded to a lower surface of the top cover 122. After welding, the first tab 32 does not cover the liquid injection hole 12211. After the cover assembly 12 is assembled, it is coaxially attached to the housing body 11, and sides are circumferentially welded and sealed. The electrolyte solution is injected into the accommodation cavity 13 from the liquid injection hole 12211. The third groove 12213 is configured to buffer the electrolyte solution. After liquid injection, the sealing cover 20 is covered on the liquid injection hole 12211. The second cover area 22 and the top cover 122 abut against each other for welding and sealing, and the sealing cover 20 and the liquid injection hole 12211 are approximately coaxial.

It should be noted that conventional batteries have a problem of poor reliability. This is because in the conventional battery, a positive conductive member is connected to an outermost side of the battery. When internal pressure of the battery is too high, the pressure directly pushes the positive conductive member away.

According to the battery in the present disclosure, the positive conductive member is connected to an inner side of a negative conductive member. When the positive conductive member located on an inner side of the battery is under relatively large pressure, it presses against the negative conductive member, and the negative conductive member shares a part of the pressure, to reduce the pressure on the positive conductive member and prevent the positive conductive member from being directly pushed away, thereby improving the reliability of the battery.

The battery in the embodiment of the present disclosure is described below with reference to the accompanying drawings. It should be noted that in the present disclosure, an example in which the battery is a button cell is used for description. A button battery refers to a battery with a button-like appearance and size. Generally, a button battery has a large diameter and small thickness. Therefore, classification of the button batteries is made based on their appearances.

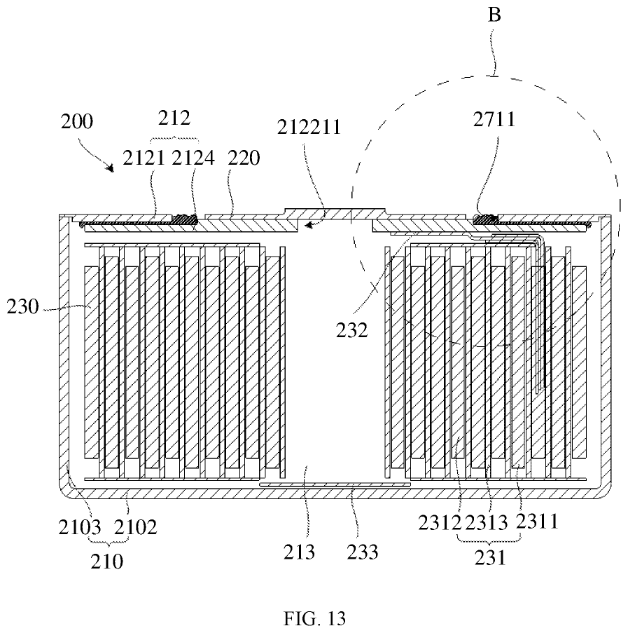

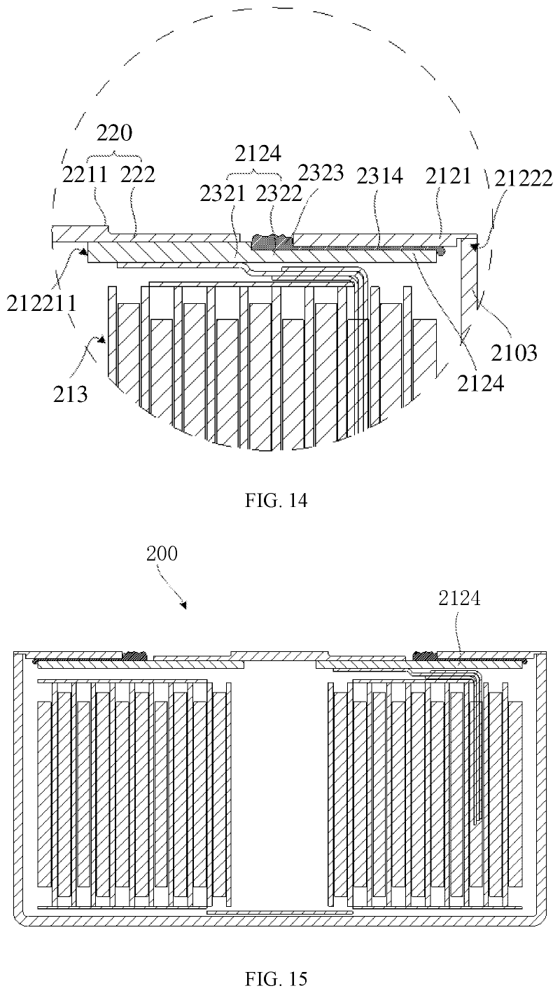

FIG. 11 is a schematic diagram of a structure of a battery according to another embodiment of the present disclosure. FIG. 12 is a top view of a battery according to an embodiment of the present disclosure. FIG. 13 is a cross-sectional view along a line A-A in FIG. 12. FIG. 14 is a locally enlarged view of a position B in FIG. 13.

Refer to FIG. 11, FIG. 12, FIG. 13, and FIG. 14. An embodiment of the present disclosure provides a battery 200. The battery 200 includes: a housing 210 (also referred to as a lower housing below), a cover assembly 212 (also referred to as a cover plate assembly), and a battery cell 230 (also referred to as an electrode assembly).

An accommodation cavity 213 is formed inside the housing 210. The cover assembly 212 may cover the top of the housing 210. The battery cell 230 is disposed in the accommodation cavity 213.

The cover assembly 212 may include a cover plate 2121 (which may be, for example, a conductive member, that is, a first conductive member) and a second conductive member 2124. The battery 200 may further include a sealing cover 220 (also referred to as a sealing member). The cover plate 2121 is connected to the top of the housing 210, and the cover plate 2121 is provided with a through-hole 2711. The second conductive member 2124 is insulatedly connected to a surface, close to the accommodation cavity 213, of the cover plate 2121. At least a partial structure of the second conductive member 2124 is exposed from the through-hole 2711. A part of the second conductive member 2124 exposed from the through-hole is provided with a liquid injection hole 212211 (also referred to as a liquid injection port). The sealing cover 220 is located on the second conductive member 2124 and covers the liquid injection hole 212211.

In the foregoing solution, because the second conductive member 2124 is connected to the surface, close to the accommodation cavity 213, of the cover plate 2121. In other words, the second conductive member 2124 is connected to an inner surface of the cover plate 2121, and at least a partial structure of the second conductive member 2124 is exposed to the outside of the battery 200 through the through-hole 2711 on the cover plate 2121. During use of the battery 200, if there is relatively large internal pressure, the second conductive member 2124 bears relatively large pressure toward the outside of the battery 200. A part, corresponding to the cover plate 2121, of the second conductive member 2124 is blocked by the cover plate 2121 fixedly connected to the housing 210, to prevent the second conductive member 2124 from being pushed away due to excessive internal pressure. The cover plate 2121 overally offsets a portion of the pressure, and pressure on the second conductive member 2124 is shared, which effectively avoids a case in which the second conductive member 2124 is pushed up in the conventional technology.

In the embodiment of the present disclosure, the battery cell 230 may include a battery cell body 231 (also referred to as a jelly roll), a first tab 232, and a second tab 233. The battery cell body 231 includes a first electrode 2311 (also referred to as a first electrode plate), a second electrode 2312 (also referred to as a second electrode plate), the separator 2313, and the like. Specifically, the battery cell body 231 may be a cylindrical rolling body and is disposed in the accommodation cavity 213. The accommodation cavity 213 also accommodates an electrolyte solution. The first electrode 2311 and the second electrode 2312 are separated by the separator 2313, and rolled together.

The first electrode 2311 is electrically connected to the second tab 233, and the second electrode 2312 is electrically connected to the first tab 232. The first tab 232 and the second tab 233 may be respectively led out from both ends of the battery cell body 231. Specifically, the first electrode 2311 has foil uncoated regions at a rolling head end and a rolling tail end, and the second electrode 2312 has foil uncoated regions at a rolling head end and a rolling tail end. The second tab 233 is electrically connected to the foil uncoated region at the rolling tail end of the first electrode 2311, and the first tab 232 is electrically connected to the foil uncoated region at the rolling tail end of the second electrode 2312.

Certainly, the present disclosure is not limited thereto. A connection position of the second tab 233 on the first electrode 2311 may alternatively be another position, and a connection position of the first tab 232 on the second electrode 2312 may alternatively be another position.

In addition, the second tab 233 is connected to the housing 210, and the housing 210 is electrically connected to the cover plate 2121. Therefore, the second tab 233 is electrically connected to the cover plate 2121, and the second conductive member 2124 is electrically connected to the first tab 232.

In the embodiment of the present disclosure, the housing 210 may be a metal housing, and a cross-sectional shape of the housing 210 is not limited to a circle, and may also be an ellipse, a polygon, or the like.

It should be noted that in the embodiment of the present disclosure, an example in which the cover plate 2121 is a negative conductive member and the second conductive member 2124 is a positive conductive member is used for description. However, the present disclosure is not limited thereto. Alternatively, the cover plate 2121 may be a positive conductive member, and the second conductive member 2124 is a negative conductive member.

For example, with reference to FIG. 13, the housing 210 includes a bottom wall 2102 and a side wall 2103 arranged around an edge of the bottom wall 2102, so that the housing 210 forms a canopy-shaped member. A second chamfering structure may be further disposed at a connection position between the side wall 2103 and the bottom wall 2102 of the housing 210, and an angle of the second chamfering structure may range from 5° to 90°.

Refer to FIG. 13 and FIG. 14. A top end of the side wall 2103 may be connected to an edge portion of the cover plate 2121. For example, the edge portion of the cover plate 2121 may be connected to the top end of the side wall 2103 through laser welding. In this way, the cover plate 2121 is actually connected to an opening of the housing 210 to form a closed space for the accommodation cavity 213. In addition, chamfer may also be disposed at a connection position between the cover plate 2121 and the housing 210, and an angle of the chamfer may range from 5° to 90°.

Certainly, in order to facilitate welding of the cover plate 2121 and the side wall 2103, thinning design may be considered for the edge of the cover plate 2121. For example, the cover plate 2121 has a positioning recess 21222 at a position near the edge. The positioning recess 21222 is located on a surface, facing the battery cell, of the cover plate 2121, the top end of the side wall 2103 is connected to the positioning recess 21222, and the positioning recess 21222 corresponds to the top end of the side wall 2103. Therefore, the positioning recess 21222 forms an annular structure. For example, a depth of the positioning recess 21222 may range from 0.05 mm to 0.1 mm.

In the embodiment of the present disclosure, the positioning recess 21222 extends to a side surface of the edge of the cover plate 2121. A first chamfer structure is formed between a bottom wall and a side wall of the positioning recess 21222, and an angle of the first chamfer structure ranges from 5° to 90°.

In the embodiment of the present disclosure, the cover plate 2121 is provided with the through-hole 2711, and the second conductive member 2124 is insulatedly connected to the surface, close to the accommodation cavity 213, of the cover plate 2121, so that at least a partial structure of the second conductive member 2124 is exposed to the outside of the accommodation cavity 213 through the through-hole 2711. It can be understood that the insulated connection herein may be connection, for example, through insulation glue, or an insulation layer may be disposed between the cover plate 2121 and the second conductive member 2124. The cover plate 2121 and the second conductive member 2124 may alternatively be connected through welding.

Refer to FIG. 11. When viewed from the entire outside of the battery 200, the housing 210 and the cover plate 2121 form the first electrode of the battery 200, for example, a negative electrode. The sealing cover 220 forms the second electrode of the battery 200, for example, a positive electrode. Because a partial structure of the second conductive member 2124 is exposed to the outside of the battery 200 through the through-hole 2711, and the sealing cover 220 is formed on the partially exposed area of the second conductive member 2124, both the first electrode and the second electrode of the battery may be arranged on a top side of the battery 200.

Refer to FIG. 13 and FIG. 14, in order to facilitate injection of the electrolyte solution into the battery 200, arrangement of a liquid injection hole 212211 on the second conductive member 2124 may be considered. For example, a liquid injection hole 212211 is disposed on a part of the second conductive member 2124 exposed from the through-hole, and the sealing cover 220 may be connected to the exposed area to cover the liquid injection hole 212211. Certainly, in order to facilitate installation, the sealing cover 220 needs to be disposed on an outer surface of the second conductive member 2124.

Herein, the sealing cover 220 may be connected to the second conductive member 2124 through laser welding or resistance welding, or may be connected to the second conductive member 2124 in another manner. It should be noted that the connection between the sealing cover 220 and the second conductive member 2124 is a sealed connection to prevent the electrolyte solution from being leaked therefrom.

Specific structures and connection manners of the second conductive member 2124, the sealing cover 220, and the cover plate 2121 are described below.

With reference to FIG. 13, as mentioned above, the sealing cover 220 is welded to the second conductive member 2124. In order to prevent the second conductive member 2124 from being welded through, a position at which the second conductive member 2124 is welded to the sealing cover 220 may be partially thickened.

With reference to FIG. 14, for example, the second conductive member 2124 includes a first connection portion 2321 and a second connection portion 2322 disposed around an outer edge of the first connection portion 2321. A thickness of the first connection portion 2321 is greater than a thickness of the second connection portion 2322, and the first connection portion 2321 may be located in the through-hole 2711. The sealing cover 220 may be connected to a surface, facing away from the accommodation cavity 213, of the first connection portion 2321. For example, the thickness of the second connection portion 2322 may range from 0.2 mm to 0.5 mm, and the thickness of the first connection portion 2321 may range from 0.1 mm to 0.3 mm. A thickness difference between the first connection portion 2321 and the second connection portion 2322 ranges from 0 mm to 0.4 mm.

In this case, there may be a spacing between a side wall of the second connection portion 2322 and an inner wall 2103 of the through-hole 2711 on the cover plate 2121, and an isolation layer 2323 may be disposed in the spacing, so that the second connection portion 2322 is electrically isolated from the cover plate 2121. In other words, the isolation layer 2323 is sandwiched between the side wall of the first connection portion 2321 and the hole wall of the through-hole 2711.

In addition, the second connection portion 2322 is insulatedly connected to the cover plate 2121, and the second connection portion 2322 may be located in the through-hole 2711. For example, an insulation glue layer 2314 is sandwiched between the cover plate 2121 and the second connection portion 2322, and the second connection portion 2322 may be bonded to the cover plate 2121 through the insulation glue layer 2314. Certainly, an arrangement range of the insulation glue layer 2314 needs to cover an overlap between the cover plate 2121 and the second connection portion 2322, to achieve an effect of sealing and connecting the cover plate 2121 and the second conductive member 2124.

For example, a thickness of the isolation layer 2323 and a thickness of the insulation glue layer 2314 each may range from 5 μm to 200 μm. The isolation layer 2323 may be made of insulation glue, and in this case, the insulation glue layer 2314 and the isolation layer 2323 may be integrally formed.

In a possible implementation, a surface, facing the inside of the accommodation cavity, of the first connection portion 2321 is flush with a surface, facing the inside of the accommodation cavity 213, of the second connection portion 2322. That is, an inward surface of the first connection portion 2321 is flush with an inward surface of the second connection portion 2322, and a thickness difference is reflected on outward surfaces of the first connection portion 2321 and the second connection portion 2322.

For example, a top surface of the first connection portion 2321 is flush with a top surface of the cover plate 2121; or a height of the top surface of the first connection portion 2321 relative to the bottom of the battery is higher than a height of the top surface of the cover plate 2121 relative to the bottom of the battery; or a height of the top surface of the first connection portion 2321 relative to the bottom of the battery is lower than a height of the top surface of the cover plate 2121 relative to the bottom of the battery.

For example, a height difference between the top surface of the first connection portion 2321 and the top surface of the cover plate 2121 ranges from −0.1 mm to 0.1 mm.

In the embodiment of the present disclosure, the liquid injection hole 212211 is formed on the second conductive member 2124, and the liquid injection hole 212211 may be used for injection of the electrolyte solution into the housing 210. Herein, the liquid injection hole 212211 may be formed on the first connection portion 2321.

FIG. 15 is a schematic overall structural diagram of another structure of a battery 200 according to an embodiment of the present disclosure.

With reference to FIG. 15, in another possible implementation, based on the foregoing solution, a structure of the second conductive member is improved. Remaining structures of the battery are similar to those in FIG. 13, and are not described herein again. The second conductive member 2124 may also be arranged as a flat plate structure, whose parts have approximately the same thickness dimensions.

A specific structure of the sealing cover 220 is described below with reference to FIG. 13 and FIG. 14.

As mentioned above, the sealing cover 220 is welded to the first connection portion 2321 of the second conductive member 2124 and is exposed to the outside of the battery 200 through the through-hole 2711.

In the embodiment of the present disclosure, in order to facilitate connection between the sealing cover 220 and external components such as conductive wires or conductive sheets, a surface, closed to the outside of the battery 200, of the sealing cover 220 may be arranged as a boss structure.

For example, the sealing cover 220 includes a second cover area 222 (which may be referred to as, for example, a body portion) and a protruding portion 2211 protruding from a surface of the second cover area 222 (that is, the first cover area may be understood as a protruding portion and an area below the protruding portion and corresponding to the second cover area). The protruding portion 2211 is located on a side, away from the accommodation cavity 213, of the second cover area 222. A connection position between the protruding portion 2211 and the second cover area 222 may be of an inverted-round structure. An outer surface of the protruding portion 2211 may be parallel to a thickness direction of the battery 200. The outer surface of the protruding portion 221 may alternatively have a specific angle with the thickness direction of the battery 200, that is, may be inclined for arrangement.

Both the second cover area 222 and the protruding portion 2211 may be formed as rotary body such as a rounded table shape, that is, with a circular cross section. When the cross section of the protruding portion 2211 is circular, a diameter of the circular cross section may range from 1.0 mm to 3.0 mm. Certainly, cross sections of the second cover area 222 and the protruding portion 2211 may alternatively be other shapes. This is not specifically limited in the present disclosure.

It should be noted that a top surface of the protruding portion 2211 is flush with a top surface of the cover plate 2121; or a height of the top surface of the protruding portion 2211 relative to the bottom of the battery is higher than a height of the top surface of the cover plate 2121 relative to the bottom of the battery; or a height of the top surface of the protruding portion 2211 relative to the bottom of the battery is lower than the height of the top surface of the cover plate 2121 relative to the bottom of the battery.

In a specific example, a top surface of the second cover area 222 of the sealing cover is flush with the top surface of the cover plate 2121, and an isolation layer 2323 may be formed between a side wall of the second cover area 222 of the sealing cover and a side wall of the cover plate 2121, thereby effectively securing the sealing cover 220 and preventing the sealing cover 220 from being pushed away due to relatively large internal pressure. In the example in which the insulation glue layer 2314 is sandwiched between the cover plate 2121 and the second connection portion 2322, the insulation glue layer 2314 may be extended to a position between the side wall of the second cover area 222 of the sealing cover and the side wall of the cover plate 2121, to form the isolation layer 2323, thereby expanding a bonding area between the sealing cover 220 and the cover plate 2121 and between the second conductive member 2124 and the cover plate 2121, and improving stability of the sealing cover 220 and the second conductive member 2124.

For example, a height difference between the top surface of the protruding portion 2211 and the top surface of the cover plate 2121 ranges from −150 μm to 150 μm.

With reference to FIG. 14, for example, a thickness of the protruding portion 2211 ranges from 2 μm to 300 μm, and a thickness of the second cover area 222 ranges from 0.05 mm to 0.2 mm.

In addition, the thickness of the second cover area 222 of the sealing cover 220 is less than or equal to the thickness of the second connection portion 2322. In other words, the thickness of the second cover area 222 of the sealing cover 220 is less than or equal to a thickness of the second conductive member 2124. For example, the thickness of the second cover area 222 of the sealing cover may be 0 μm to 500 μm smaller than the thickness of the second connection portion 2322.

In the embodiment of the present disclosure, with reference to FIG. 13, the liquid injection hole 212211 may be located at a center position of the second conductive member 2124. This is convenient for both processing and liquid injection. A diameter of the liquid injection hole 212211 may be determined according to actual needs, and is not limited in the present disclosure.

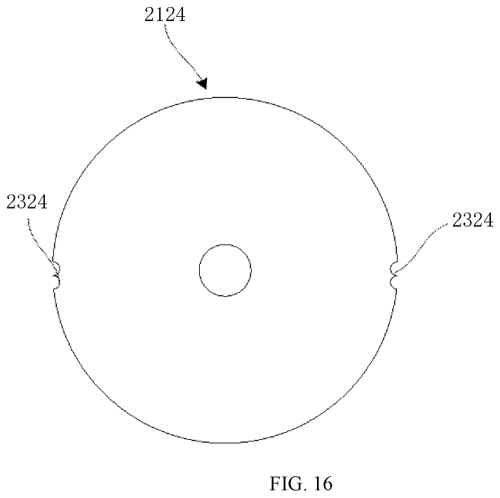

FIG. 16 is a schematic diagram of a structure of a second conductive member 2124 in a battery 200 according to an embodiment of the present disclosure. With reference to FIG. 16, an outer contour edge of the second conductive member 2124 is provided with a positioning mark 2324. The positioning mark 2324 is used to indicate a welding position of the first tab 232 on the second conductive member 2124. Herein, the positioning mark 2324 may be a notch formed on the second conductive member 2124, and there may be at least one notch.

For example, there are two positioning marks 2324, and the two positioning marks 2324 may be arranged symmetrically with respect to the center of the second conductive member 2124.

In the embodiment of the present disclosure, as mentioned above, the battery cell body 231 includes a first electrode 2311 and a second electrode 2312. The first electrode 2311 includes a first current collector and a first active material disposed on a related surface of the first current collector, and the second electrode 2312 includes a second current collector and a second active material disposed on a related surface of the second current collector.

For example, the second active material may include at least one of lithium cobalt oxide, lithium manganate, or lithium ferrous phosphate. More specifically, a particle size, a press density, a crystal structure, and the like are limited, and a positive active material capable of lithiation and delithiation is selected as the second active material, for example, a lithium-containing compound such as lithium oxide, lithium phosphorus oxide, lithium sulfide, or lithium-containing interlayer compound, which may be exemplified as lithium metal composite oxide. A metal element included in the lithium metal composite oxide is, for example, at least one of Mg, Al, Ca, Sc, Ti, V, Cr, Mn, Fe, Co, Ni, Cu, Zn, Ga, Ge, Y, Zr, Sn, Sb, W, Pb, or Bi. Furthermore, at least one of Co, Ni, Mn or Al may be included. Appropriate examples of the lithium metal composite oxide, may include lithium metal composite oxide containing Co, Ni, and Mn, and lithium metal composite oxide containing Co, Ni, and Al.

For the first active material, only a condition that the material can absorb and release lithium ions needs to be met. For example, a carbon material, lithium metal, metal capable of forming an alloy with lithium, an alloy compound containing the metal, or the like may be used as an example. The carbon material may use graphite such as natural graphite, non-graphitizable carbon, or artificial graphite, or coke. At least one metal capable of forming an alloy with lithium may be used as an example for the alloy compound. An element that can form an alloy with lithium may use silicon or tin, or may use silicon oxide, tin oxide, or the like that is formed by combining it with oxygen. In addition, a mixture of the foregoing carbon material and a compound of silicon or tin may be used. In addition, a material, having a charge-discharge potential of metal lithium higher than a carbon material, such as lithium titanate, may also be used.

The electrolyte solution may use a non-aqueous electrolyte. The non-aqueous electrolyte includes a non-aqueous solvent and an electrolyte salt dissolved in the non-aqueous solvent. The non-aqueous electrolyte is not limited to a liquid electrolyte (non-aqueous electrolyte solution), and may also be a solid electrolyte using a gel polymer or the like.

The electrolyte solution may be a mixed organic solvent selected from at least one of the following: propylene carbonate (PC), ethylene carbonate (EC), diethyl carbonate (DEC), dimethyl carbonate (DMC), dipropylene carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), γ-butyrolactone (GBL), fluoroethylene carbonate (FEC), methyl formate, ethyl formate, propyl formate, methyl acetate, ethyl acetate, propyl acetate, amyl acetate, methyl propionate, ethyl propionate, or butyl propionate. In addition, the electrolyte solution according to the present disclosure may further include a lithium salt, and anions of the lithium salt may be selected from at least one of the following: F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, F₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

An assembly process of the battery 200 in the present disclosure is described below.

Step 1: First bend a second tab 233, and connect one end of the second tab 233 to a corresponding electrode plate of a battery cell body 231. It should be noted that after the second tab 233 is bent, the other end should be kept parallel to an end surface of the battery cell body 231.

Bend a first tab 232, and connect the one end of the first tab 232 to a corresponding electrode plate of the battery cell body 231. It should be noted that after the first tab 232 is bent, the other end should keep parallel to the end surface of the battery cell body 231.

Step 2: Place the battery cell body 231 connected to the first tab 232 and the second tab 233 into an accommodation cavity 213, weld the second tab 233 to a housing 210 through laser welding or resistance welding, and weld the first tab 232 to a second conductive member 2124 through laser welding or resistance welding.

Step 3: Apply insulation glue between the second conductive member 2124 and a cover plate 2121, bond them together, and weld the cover plate 2121 to the housing 210 through laser welding or resistance welding, and then place them into an oven for drying.

Step 4: Inject an electrolyte solution into the inside of the housing 210 through a liquid injection hole 212211. Weld the sealing cover 220 to the second conductive member 2124 through laser welding or resistance welding to complete assembly of the battery 200.

Step 5: Perform an electrical performance test on the battery 200.

In the embodiment, because the second conductive member 2124 is connected to a surface, close to the accommodation cavity 213, of the cover plate 2121. In other words, the second conductive member 2124 is connected to an inner surface of the cover plate 2121, and at least a partial structure of the second conductive member 2124 is exposed to the outside of the battery 200 through the through-hole 2711 on the cover plate 2121. During use of the battery 200, if there is relatively large internal pressure, when the second conductive member 2124 bears relatively large pressure toward the outside of the battery 200. A part, located on an inner side of the cover plate 2121, of the second conductive member 2124 is blocked by the cover plate 2121. The pressure is transferred from the second conductive member 2124 to the cover plate 2121. The cover plate 2121 overally offsets a portion of the pressure, and pressure on the second conductive member 2124 is shared, which effectively avoids a case in which the cover plate of the battery 200 is easily pushed up in the conventional technology.

The present disclosure further provides an electronic device, including: an electronic device body and the foregoing battery 200. The battery 200 provides electric energy for the electronic device body.

A structure of the battery in the electronic device provided in the present disclosure is the same as the structure of the battery described above, and can bring about the same or similar technical effect, which is not described herein again.

In the descriptions of the present disclosure, it should be understood that the orientations or positional relationships indicated by the terms “center”, “vertical”, “transverse”, “length”, “width”, “thickness”, “upper”, “lower”, “front”, “rear”, “left”, “right”, “perpendicular”, “horizontal”, “top”, “bottom”, “inside”, “outside”, and the like are based on the orientations or positional relationships shown in the accompanying drawings, are merely intended to facilitate the descriptions of the present disclosure and simplify the descriptions, are not intended to indicate or imply that the apparatuses or components mentioned in the present disclosure must have specific orientations, or be constructed and operated for a specific orientation, and therefore shall not be construed as a limitation on the present disclosure.

In the descriptions of the present disclosure, it should be understood that the terms “include”, “contain” and any variant thereof are intended to cover a non-exclusive inclusion. For example, a process, method, system, product, or device that includes a list of steps or units is not necessarily limited to those steps or units that are expressly listed, but may include other steps or units not expressly listed or are inherent to the process, method, product, or device.

Unless specified and defined explicitly otherwise, the terms “mounted”, “join”, “connect”, “fixed”, and the like should be understood in a broad sense. For example, “connection” may be a fixed connection, a detachable connection, or an integral connection; or may be a direct connection or an indirect connection through an intermediate medium; or may be an internal connection or an interactive relationship between two elements. A person of ordinary skill in the art may understand specific meanings of these terms in the present disclosure based on specific situations. In addition, the terms “first”, “second”, and the like are merely intended for a purpose of description, and shall not be understood as an indication or implication of relative importance or implicit indication of the number of indicated technical features.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of the present disclosure.

What is claimed is:

1. A battery, comprising a housing, a sealing cover, and a battery cell, wherein
the housing has an accommodation cavity, and the battery cell is located inside the accommodation cavity;
the housing is provided with a liquid injection hole, the liquid injection hole is communicated with the accommodation cavity, and the sealing cover is seal-welded to the housing to cover the liquid injection hole;
an upper surface of a peripheral edge of the sealing cover is provided with a first step, the first step divides the sealing cover into a first cover area and a second cover area, and a thickness of the first cover area is greater than a thickness of the second cover area; and
the thickness of the second cover area is less than or equal to a thickness of the housing at a seal-welding position with the second cover area.

2. The battery according to claim 1, further comprising an adapter, wherein
the adapter is welded to an upper surface of the first cover area, and a thickness of the adapter is less than or equal to a thickness of the first cover area at a welding position with the adapter.

3. The battery according to claim 1, wherein the housing comprises: a housing body and a cover assembly;
the housing and the cover assembly enclose the accommodation cavity;
the cover assembly comprises: a cover plate, a top cover, and a first insulation member;
the cover plate is seal-welded to the housing body, the cover plate is provided with a through-hole, the top cover is provided with a recessed portion, the recessed portion is located in the through-hole, the recessed portion is provided with the liquid injection hole, and the first insulation member is disposed between the top cover and the cover plate, to insulatedly connect the top cover and the cover plate; and
a first groove is formed above the recessed portion, and the sealing cover is disposed in the first groove.

4. The battery according to claim 3, wherein
a second step is disposed on a lower surface of a peripheral edge of the cover plate, and the second step is seal-welded to the housing.

5. The battery according to claim 3, wherein
a second groove is disposed on an upper surface of the cover plate, and at least a part of the first insulation member is disposed in the second groove.

6. The battery according to claim 3, wherein
a third groove is formed on the upper surface of the recessed portion, the liquid injection hole is located in the third groove, and the sealing cover covers the third groove; and
an aperture of the third groove is greater than an aperture of the liquid injection hole.

7. The battery according to claim 4, wherein the battery cell comprises a battery cell body and a first tab and a second tab connected to the battery cell body; and
the first tab is connected to the top cover, and the second tab is connected to the housing body.

8. The battery according to claim 7, further comprising a second insulation member, wherein the second insulation member is disposed on an upper surface and/or a lower surface of the battery cell body.

9. The battery according to claim 7, further comprising a third insulation member, wherein the third insulation member is disposed between the cover plate and the first tab.

10. The battery according to claim 7, further comprising: protective glue, wherein the protective glue covers a portion, protruding from the battery cell body, of the first tab, and/or a portion, protruding from the battery cell body, of the second tab.

11. The battery according to claim 1, wherein the housing comprises: a housing body and a cover assembly, the housing body and the cover assembly enclose the accommodation cavity, and the cover assembly comprises:
a cover plate, wherein the cover plate is connected to a top of the housing body, and the cover plate is provided with a through-hole; and a second conductive member, wherein the second conductive member is insulatedly connected to a surface, close to the accommodation cavity, of the cover plate, at least a partial structure of the second conductive member is exposed from the through-hole, and a part of the second conductive member exposed from the through-hole is provided with a liquid injection hole, wherein
the sealing cover is located on the second conductive member.

12. The battery according to claim 11, wherein the second conductive member comprises a first connection portion and a second connection portion disposed around an outer edge of the first connection portion, and a thickness of the first connection portion is greater than a thickness of the second connection portion; and the second connection portion is insulatedly connected to the cover plate, the first connection portion is located in the through-hole, and the sealing cover is connected to a surface, facing away from the accommodation cavity, of the first connection portion.

13. The battery according to claim 12, wherein an isolation layer is further disposed between the through-hole and the first connection portion, and the isolation layer is sandwiched between a side wall of the first connection portion and a hole wall of the through-hole.

14. The battery according to claim 12, wherein a top surface of the first connection portion is flush with a top surface of the cover plate; or
a height of the top surface of the first connection portion relative to a bottom of the battery is higher than a height of the top surface of the cover plate relative to the bottom of the battery; or
a height of the top surface of the first connection portion relative to the bottom of the battery is lower than a height of the top surface of the cover plate relative to the bottom of the battery.

15. The battery cell according to claim 11, wherein the first cover area comprises a protruding portion protruding from the second cover area, wherein
a top surface of the protruding portion is flush with a top surface of the cover plate; or
a height of the top surface of the protruding portion relative to a bottom of the battery is higher than a height of the top surface of the cover plate relative to the bottom of the battery; or
a height of the top surface of the protruding portion relative to the bottom of the battery is lower than a height of the top surface of the cover plate relative to the bottom of the battery.

16. The battery according to claim 11, wherein the housing body comprises a bottom wall and a side wall surrounding and connected to an edge of the bottom wall, and a top of the side wall is connected to an edge portion of the cover plate.

17. The battery according to claim 16, wherein the cover plate has a positioning recess at a position near the edge, the positioning recess is located on a surface, facing the battery cell, of the cover plate, and the top of the side wall is connected to the positioning recess.

18. The battery according to claim 11, wherein the battery cell comprises a first tab and a second tab, the second tab is electrically connected to the cover plate, and the first tab is electrically connected to the second conductive member; and
an outer contour edge of the second conductive member is provided with a positioning mark, and the positioning mark is used to indicate a welding position of the first tab on the second conductive member.

19. A battery, comprising:
a housing, wherein the housing has an accommodating cavity;
a battery cell, wherein the battery cell is located inside the accommodation cavity;
a cover assembly, wherein the cover assembly is disposed on the housing, and the cover assembly comprises: a cover plate, wherein the cover plate is connected to a top of the housing, and the cover plate is provided with a through-hole; and a second conductive member, wherein the second conductive member is insulatedly connected to a surface, close to the accommodation cavity, of the cover plate, at least a partial structure of the second conductive member is exposed from the through-hole, and a part of the second conductive member exposed from the through-hole is provided with a liquid injection hole; and
a sealing cover located on the second conductive member, wherein the sealing cover covers the liquid injection hole.

20. An electric device, comprising an electronic device body and the battery according to claim 1, wherein the battery provides electric energy for the electronic device body.
